(19) United States
(12) Patent Application Publication
(10) Pub. No.: US 2014/0160378 A1
(43) Pub. Date: Jun. 12, 2014

(54) DISPLAY APPARATUS

(71) Applicant: SAMSUNG DISPLAY CO., LTD., Yongin-city (KR)

(72) Inventors: Hyun-Cheol MOON, Anyang-si (KR); Seung-Hoon LEE, Hwaseong-si (KR)

(73) Assignee: Samsung Display Co., Ltd., Yongin-city (KR)

(21) Appl. No.: 13/868,551

(22) Filed: Apr. 23, 2013

(30) Foreign Application Priority Data
Dec. 6, 2012 (KR) 10-2012-0140905

(51) Int. Cl. G02B 27/22; G02F 1/13

(52) U.S. Cl. CPC G02B 27/2214; G02F 1/1313
USPC 349/15

(57) ABSTRACT

A display apparatus includes a display panel configured to selectively display a two-dimensional image and a three-dimensional image, a light-source unit providing the display panel with light, and a liquid crystal (“LC”) barrier panel disposed between the display panel and the light-source unit and including a unit barrier part. The unit barrier part includes a plurality of barrier electrodes driven to form a barrier blocking the light and an opening transmitting the light. An LC lens panel is disposed between the LC barrier panel and the display panel and includes a unit lens part, the unit lens part including a plurality of lens electrodes which is driven as a unit lens.

### CROSS-REFERENCE TO RELATED APPLICATION

This application claims priority from and the benefit of Korean Patent Application No. 10-2012-0140905, filed on Dec. 6, 2012, which is hereby incorporated by reference for all purposes as if fully set forth herein.

### BACKGROUND

1. Field

Exemplary embodiments of the present invention relate to a display apparatus. Exemplary embodiments of the present invention also relate to a display apparatus for selectively displaying a two-dimensional (“2D”) image and a three-dimensional (“3D”) image.

2. Discussion of the Background

In response to increased demand for a 3D image in industrial fields such as games, movies, etc., a display apparatus displaying the 3D image has been developed. 2D images different from each other are respectively provided to both eyes of an observer such that the 3D stereoscopic image are displayed. For example, the observer watches a pair of 2D images through both eyes, and then the 2D images are effectively blended and processed in the observer's brain to be recognized as the 3D stereoscopic image.

The 3D stereoscopic display apparatus may be classified into a “glasses” mode and a “no-glasses” mode according to whether the observer wears specific 3D glasses. Conventionally, the display apparatus of the “glasses” mode includes glasses of a polarized light mode and the display apparatus of the “no-glasses” mode includes a barrier panel.

In other words, the display apparatus of the “glasses” mode includes (1) an active polarizing panel which polarizes light for a left-eye image and a right-eye image displayed on the display panel different from each other; and (2) polarized light glasses which receive the differently-polarized left-eye image and the right-eye image from the active polarizing panel. The barrier panel includes a barrier blocking a light and an opening transmitting the light and, thus, a left-eye image emitted from a left-eye pixel of the display panel and a right-eye image emitted from a right-eye pixel of the display panel are provided to an observer's eyes through the barrier panel.

### SUMMARY

Exemplary embodiments of the present invention provide a display apparatus for selectively displaying a 2D image and a 3D image.

Additional features of the invention will be set forth in the description which follows, and in part will be apparent from the description, or may be learned by practice of the invention.

An exemplary embodiment of the present invention discloses a display apparatus including a display panel selectively displaying a 2D image and a 3D image, a light-source unit providing the display panel with light, a liquid crystal (“LC”) barrier panel disposed between the display panel and the light-source unit and including a unit barrier part, the unit barrier part including a plurality of barrier electrodes which are configured to be driven as a barrier blocking the light and as an opening transmitting the light, and an LC lens panel disposed between the LC barrier panel and the display panel and including a unit lens part, the unit lens part including a plurality of lens electrodes which are configured to be driven as a unit lens.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exploded perspective view illustrating a display apparatus according to an exemplary embodiment of the present invention.

FIG. 2 is a flowchart diagram illustrating a method of displaying a 2D image and a 3D image according to the display apparatus as shown in FIG. 1.

FIG. 3A and FIG. 3B are conceptual diagrams illustrating a method of driving a liquid crystal barrier panel as shown in FIG. 1.

FIG. 4 is a conceptual diagram illustrating a method of driving a liquid crystal lens panel as shown in FIG. 1.

FIG. 5 is a cross-sectional view of a display apparatus according to an exemplary embodiment of the present invention.

FIG. 6 is a cross-sectional view of a display apparatus according to an exemplary embodiment of the present invention.

FIG. 7 is a cross-sectional view of a display apparatus according to an exemplary embodiment of the present invention.

FIG. 8 is a cross-sectional view of a display apparatus according to an exemplary embodiment of the present invention.

FIG. 9 is an exploded perspective view of a display apparatus according to an exemplary embodiment of the present invention.

FIG. 10 is an exploded perspective view illustrating a method of driving the liquid crystal barrier panel according to the display apparatus as shown in FIG. 9.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

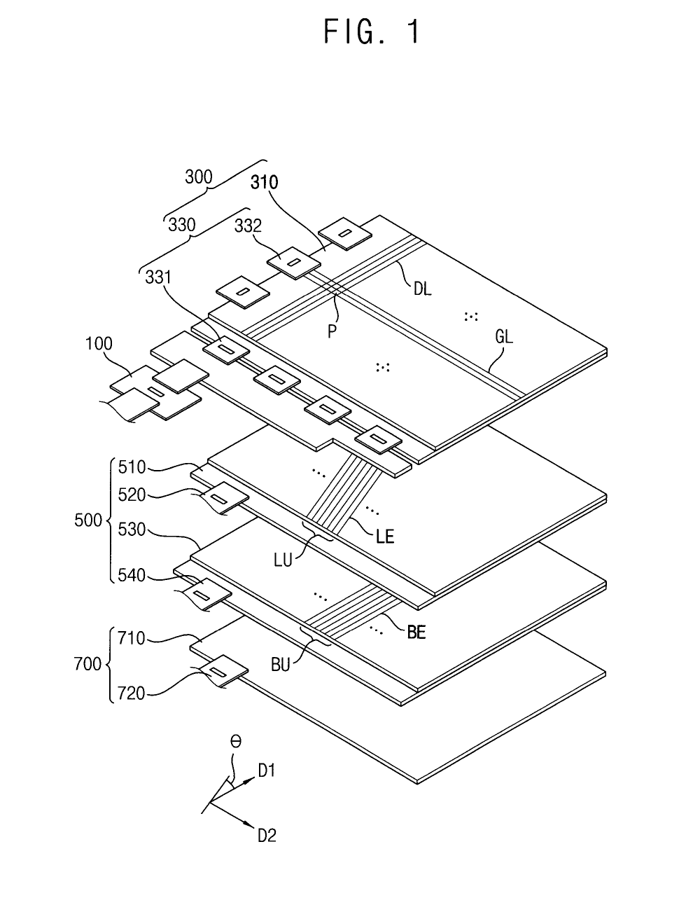

FIG. 1 is an exploded perspective view illustrating a display apparatus according to an exemplary embodiment of the present invention.

Referring to FIG. 1, the display apparatus may include a control part 100, a display part 300, a 3D switching part 500, and a light-source part 700.

The control part 100 controls an operation of the display apparatus. The control part 100 operates the display apparatus as a 3D mode for displaying a 3D image and as a 2D mode for displaying a 2D image. An operation of the control part 100 will be explained later.

The display part 300 may include a display panel 310 and a display driving part 330.

The display panel 310 may include a plurality of data lines DL, a plurality of gate lines GL, and a plurality of sub pixels P. The data lines DL extend in a first direction D1 and are arranged in a second direction D2 crossing the first direction D1. The gate lines GL extend in the second direction D2 and are arranged in the first direction D1. The sub pixels P are arranged in a matrix, and driven by the data lines DL and the gate lines GL to display an image.

The display driving part 330 may include a data driving part 331 and a gate driving part 332. The data driving part 331 provides the data lines DL with a data signal. The gate driving part 332 provides the gate lines GL with a gate signal. In the 3D mode, the display driving part 330 alternately displays a left-eye image and a right-eye image on the display panel 310 according to a control of the control part 100. For example, the display driving part 330 displays the left-eye image on the display panel 310 during a first sub frame and displays the right-eye image on the display panel 310 during a second sub frame, at a frame frequency of about 120 Hz. In the 2D mode, the display driving part 330 repetitively displays the 2D image on the display panel 310 during the first and second sub frames at the frame frequency of about 120 Hz. In addition, the display driving part 330 may display the 2D image on the display panel 310 at the frame frequency of about 60 Hz.

The 3D switching part 500 may include an LC lens panel 510, a lens driving part 520, an LC barrier panel 530, and a barrier driving part 540.

The LC lens panel 510 is disposed under the display panel 310 and includes a plurality of unit lens parts LU. Each of the unit lens parts LU includes a plurality of lens electrodes LE. The lens electrodes LE extend in the first direction D1 and are arranged in the second direction D2. The lens electrodes LE in the unit lens part LU are operated as a unit lens in the 3D mode.

The lens driving part 520 provides the lens electrodes LE of the unit lens part LU with driving signals according to a control of the control part 100. In the 3D mode, the lens driving part 520 operates the unit lens part LU as the unit lens for the 3D, for example, a lenticular lens, a Fresnel lens, etc. In the 2D mode, the lens driving part 520 operates the unit lens part LU as a transparent panel which does not diffract the light and uniformly transmits the light to an overall area. Therefore, in the 3D mode, the LC lens panel 510 is operated in a lens mode so that the light passing through the LC lens panel 510 is diffracted to an area, for example, in which an observer's left-eye or right-eye is located. In the 2D mode, the LC lens panel 510 is operated as the transparent panel so that the light passing through the LC lens panel 510 is uniformly transmitted to the overall area.

The LC barrier panel 530 is disposed under the LC lens panel 510, and includes a plurality of unit barrier parts BU. Each of the unit barrier parts BU includes a plurality of barrier electrodes BE. The barrier electrodes BE extend in the first direction D1 and are arranged in the second direction D2, such as a bar shape.

The barrier driving part 540 provides the barrier electrodes BE of the unit barrier part BU with driving signals according to a control of the control part 100. In the 3D mode, the barrier driving part 540 drives the unit barrier part BU as an opening transmitting the light and as a barrier blocking the light. In addition, the barrier driving part 540 controls a position of the barrier according to the left-eye image and the right-eye image displayed on the display panel 310 based on a control of the control part 100. For example, during a first sub frame during which the display panel 310 displays the left-eye image, a first area of the unit barrier part BU may be operated as the barrier and a second area of the unit barrier part BU is operated as the opening. During a second sub frame during which the display panel 310 displays the right-eye image, the first area of the unit barrier part BU may be operated as the opening and the second area of the unit barrier part BU may be operated as the barrier.

Therefore, the light passing through the unit barrier part BU is concentrated in an area in which the observer's left-eye is located during the first sub frame during which the display panel 310 displays the left-eye image. Then, the light passing through the unit barrier part BU is concentrated in an area in which the observer's right-eye is located during the second sub frame during which the display panel 310 displays the right-eye image.

The barrier driving part 540 drives an overall area of the unit barrier part BU as the opening. Thus, in the 2D mode, the light passing from the barrier driving part 540 is uniformly transmitted to an overall area through the LC barrier panel 530 operated as the transparent panel.

The light-source part 700 may include a light-source unit 710 and a light-source driving part 720.

The light-source unit 710 is disposed under the LC lens panel 530 and generates the light. The light-source unit 710 may have an edge-illuminating type which includes a light guide plate (“LGP”) and at least one light-source disposed at an edge of the LGP. Alternatively, the light-source unit 710 may have a direct-illuminating type which includes at least one light-source directly disposed facing a rear surface of the LC lens panel 530.

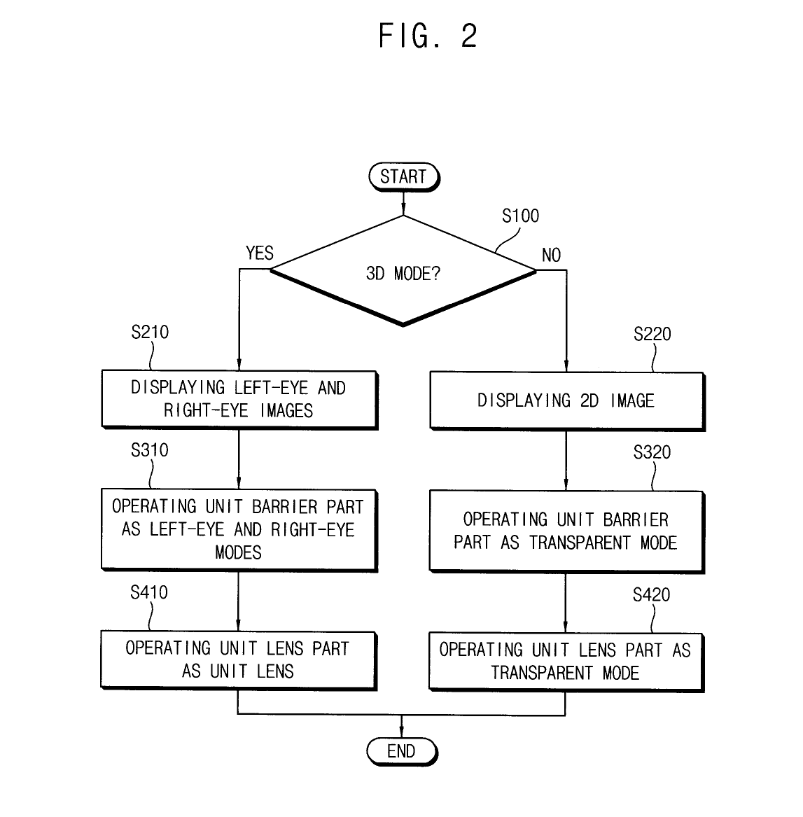

FIG. 2 is a flowchart diagram illustrating a method of displaying a 2D image and a 3D image according to the display apparatus as shown in FIG. 1.

Referring to FIGS. 1 and 2, an observer may select the display apparatus to be driven either in the 3D mode for displaying the 3D image or in the 2D mode for displaying the 2D image.

For example, the control part 100 determines the image mode (step S100).

In the 3D mode, the control part 100 controls the display driving part 330 to display the 3D image on the display panel 310. The display panel 310 displays the left-eye image during the first sub frame and the right-eye image during the second sub frame (step S210). The display panel 310 may be driven at a frame frequency of about 120 Hz.

The control part 100 controls the 3D switching part 500 based on the left-eye image and the right-eye image displayed on the display panel 310. The barrier driving part 540 drives the unit barrier part BU of the LC barrier panel 530 as a left-eye mode during the first sub frame during which the display panel 310 displays the left-eye image. The barrier driving part 540 drives the unit barrier part BU of the LC barrier panel 530 as a right-eye mode during the second sub frame during which the display panel 310 displays the right-eye image (step S310). For example, in the left-eye mode of the unit barrier part BU the first area of the unit barrier part BU is operated as the barrier and the second area of the unit barrier part BU is operated as the opening. In addition, in the right-eye mode of the unit barrier part BU the first area of the unit barrier part BU is operated as the opening and the second area of the unit barrier part BU is operated as the barrier. The LC barrier panel 530 may be driven at a frame frequency of about 120 Hz, in synchronization with a driving period of the display panel 310.

In synchronization with a driving period of the LC barrier panel 530, the lens driving part 520 drives the LC lens panel 510 as the unit lens for 3D (step S410). The LC lens panel 510 is operated as a plurality of unit lenses during the first sub frame and the second sub frame. The LC lens panel 510 may be driven at a frame frequency of about 60 Hz or 120 Hz.

Therefore, in the 3D mode, during the first sub frame, the light generated from the light-source part 700 passes through the 3D switching part 500 and the display panel 310 displaying the left-eye image, so that the light of the left-eye image may be incident on the observer's left-eye. Then, during the second sub frame, the light generated from the light-source part 700 passes through the 3D switching part 500 and the display panel 310 displaying the right-eye image, so that the light of the right-eye image may be incident on the observer's right-eye. Therefore, the observer may observe the 3D image during a frame period.

However, in the 2D mode, the control part 100 controls the display driving part 330 to display the 2D image on the display panel 310 (step S220). The display panel 310 may be driven at about 120 Hz so that the 2D image may be repetitively displayed on the display panel 310 as two frame pictures. Alternatively, the display panel 310 may be driven at about 60 Hz so that the 2D image may be displayed on the display panel 310 as one frame picture.

When the control part 100 controls the 3D switching part 500 to be in the 2D mode, the barrier driving part 540 drives the LC barrier panel 530 as the transparent panel (step S320).

In addition, the lens driving part 520 drives the LC lens panel 530 as the transparent panel (step S420). The LC barrier panel 530 and the LC lens panel 510 may be driven based on the frame frequency of the display panel 310.

Therefore, in the 2D mode, the light generated from the light-source part 700 is incident on the display panel 310 displaying the 2D image via the 3D switching part 500 operated as the transparent panel. Thus, the observer may observe the 2D image.

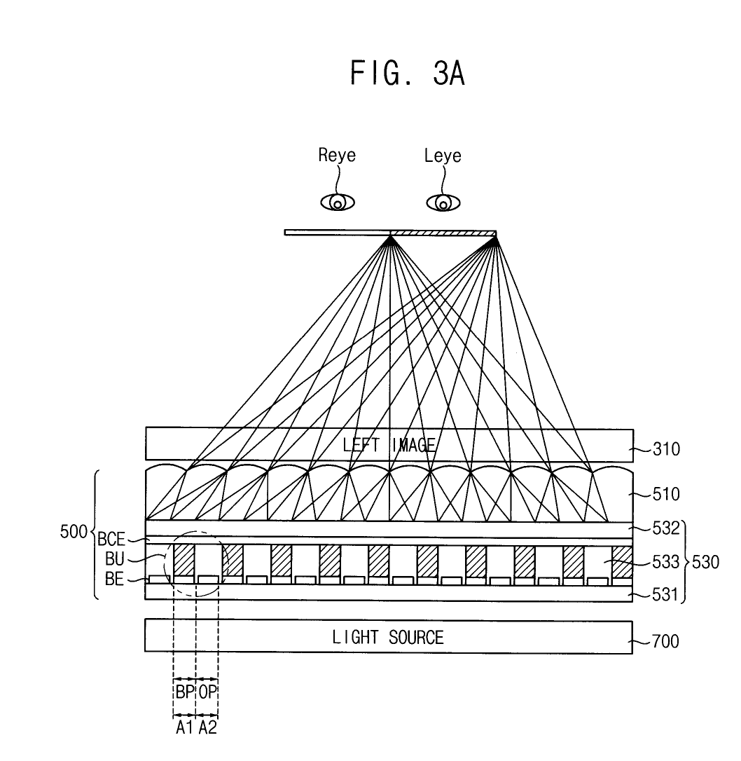

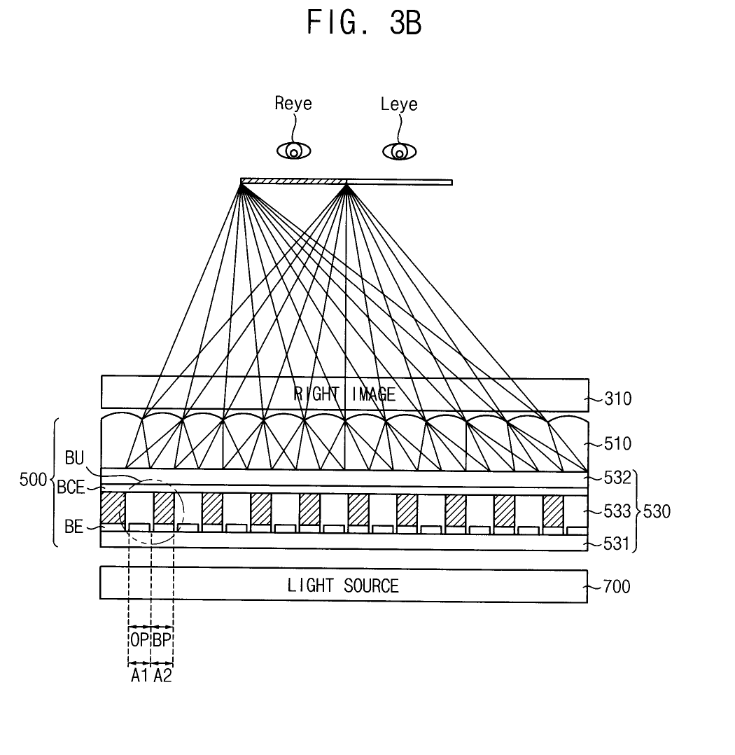

FIGS. 3A and 3B are conceptual diagrams illustrating a method of driving a liquid crystal barrier panel as shown in FIG. 1.

Referring to FIGS. 1, 3A and 3B, the 3D switching part 500 may include an LC lens panel 510 disposed under the display panel 310 and an LC barrier panel 530 disposed between the LC lens panel 510 and the light-source part 700.

The LC barrier panel 530 may include a first substrate 531, a second substrate 532, and a first LC layer 533. The first substrate 531 may include a plurality of unit barrier parts BU. Each of the unit barrier parts BU may include a plurality of barrier electrodes BE. The barrier electrodes BE extend in the first direction D1 and are arranged in the second direction D2.

The unit barrier part BU is divided into the first area A1 and the second area A2, and each of the first and second areas A1 and A2 includes at least one barrier electrode BE.

The second substrate 532 may include a barrier common electrode BCE opposing the barrier electrodes BE. The first LC layer 533 is disposed between the first substrate 531 and the second substrate 532 and operates as the opening OP transmitting the light and the barrier BP blocking the light according to a driving signal applied to the barrier electrode BE. For example, the barrier common electrode BCE always receives a second driving signal and the barrier electrodes BE selectively receive a first driving signal and a second driving signal. When the first driving signal is applied to the barrier electrode BE, an area disposed above the barrier electrode BE may be operated as the opening OP. When the second driving signal is applied to the barrier electrode BE, an area disposed above the barrier electrode BE may be operated as the barrier BP.

According to the present exemplary embodiment, during the first sub frame, the unit barrier part BU is operated in the left-eye mode corresponding to the left-eye image displayed on the display panel 310. For example, referring to FIG. 3A, in the left-eye mode the barrier electrode BE disposed in the first area A1 of the unit barrier part BU receives the second driving signal to operate as the barrier BP, and the barrier electrode BE disposed in the second area A2 of the unit barrier part BU receives the first driving signal to operate as the opening OP. Therefore, the light generated from the light-source part 700 may be concentrated in an area, in which the observer's left-eye Leye is located, by the unit barrier part BU operating in the left-eye mode.

In addition, during the second sub frame, the unit barrier part BU is operated as the right-eye mode corresponding to the right-eye image displayed on the display panel 310. For example, referring to FIG. 3B, when in the right-eye mode the barrier electrode BE disposed in the first area A1 of the unit barrier part BU receives the first driving signal to operate as the opening OP and the barrier electrode BE disposed in the second area A2 of the unit barrier part BU receives the second driving signal to operate as the barrier BP. Therefore, the light generated from the light-source part 700 may be concentrated in an area, in which the observer's right-eye Reye is located, by the unit barrier part BU operating as the right-eye mode.

Therefore, in the 3D mode, the LC barrier panel 530 may be operated as a barrier panel which concentrates the light in an area.

However, in the 2D mode, the barrier electrodes of the LC barrier panel 530 may receive the first driving signal. Therefore, the LC barrier panel 530 may be operated as the transparent panel.

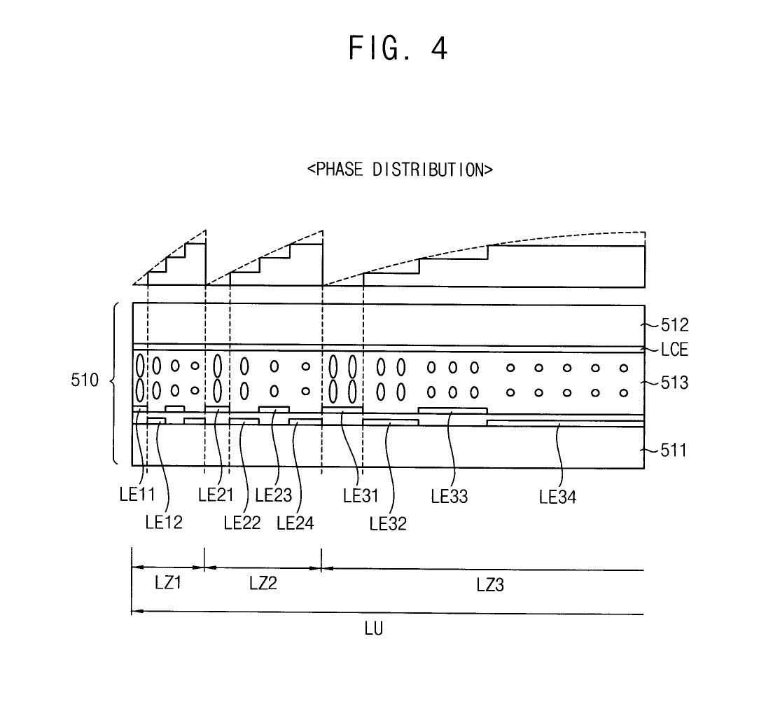

FIG. 4 is a conceptual diagram illustrating a method of driving a liquid crystal lens panel as shown in FIG. 1.

Referring to FIGS. 1 and 4, the LC lens panel 510 may include a third substrate 511, a fourth substrate 512 and a second LC layer 513.

The third substrate 511 may include a plurality of lens electrodes LE11, LE12, . . . , LE21, LE22, LE23, LE24 . . . , LE31, LE32, LE33, . . . .

The third substrate 511 may include the unit lens part LU. As shown in FIG. 4, the unit lens part LU may include a plurality of lens areas LZ1, LZ2, LZ3, . . . . For example, the unit lens part LU may include a first lens area LZ1, a second lens area LZ2, and a third lens area LZ3. A plurality of first lens electrodes LE11, LE12, . . . are disposed in the first lens area LZ1, a plurality of second lens electrodes LE21, LE22, . . . are disposed in the second lens area LZ2, and a plurality of third lens electrodes LE31, LE32, LE33, . . . are disposed in third lens area LZ3. The lens electrodes LE11, LE12, . . . , LE21, LE22, LE23, LE24 . . . , LLE31, LE32, LE33, . . . , extend in a lens axis inclined with respect to the first direction D1 and arranged in the second direction D2, such as a bar shape. The lens axis has a slope angle θ inclined with respect to the first direction D1.

As shown I FIG. 4, the lens electrodes LE31, LE32, LE33, . . . in each lens area may be arranged as a double-layer structure. End side of the lens electrodes LE32 and LE33 adjacent to each other may be disposed on a same line in a vertical direction.

The lens electrodes LE11, LE12, . . . , LE21, LE22, LE23, LE24 . . . , LLE31, LE32, LE33, . . . , receive a plurality of driving signals to operate the unit lens. For example, a first lens electrode LE21 of the lens area LZ2 receives a driving signal having a maximum level and remaining lens electrodes LE21, LE23, LE24 of the lens area LZ2 may sequentially receive the driving signals having levels which are gradually decreased.

The fourth substrate 512 includes a lens common electrode LCE opposite to the lens electrodes LE11, LE12, . . . , LE21, LE22, LE23, LE24 . . . , LLE31, LE32, LE33, . . . .

The second LC layer 513 is disposed between the third substrate 511 and the fourth substrate 512, and operated as the unit lens according to the driving signals applied to the lens electrodes LE11, LE12, . . . , LE21, LE22, LE23, LE24 . . . , LLE31, LE32, LE33, . . . .

As shown in FIG. 4, in the 3D mode, the LC lens panel 510 may operate as the unit lens which has a refractive index similar to that of the Fresnel lens.

In the 2D mode, the lens electrodes LE11, LE12, . . . , LE21, LE22, LE23, LE24 . . . , LLE31, LE32, LE33, . . . of the LC lens panel 510 receive the driving signal which is applied to the lens common electrode LCE. Thus, the LC lens panel 510 may operate as the transparent panel.

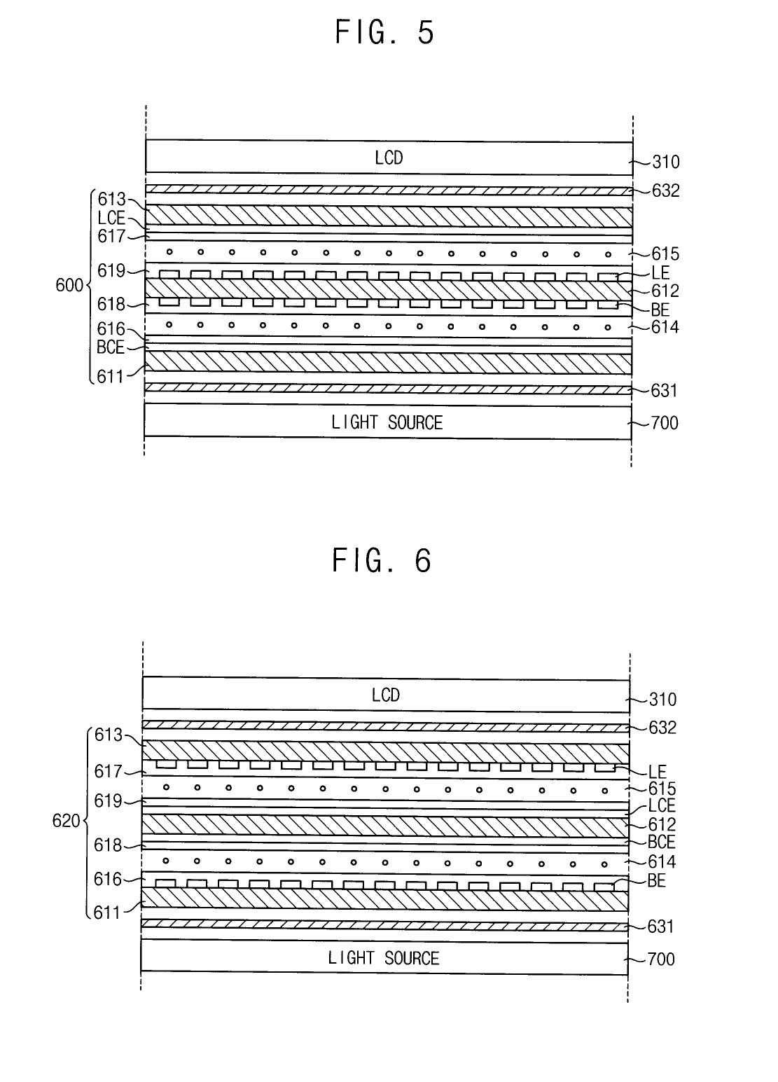

FIG. 5 is a cross-sectional view of a display apparatus according to an exemplary embodiment of the present invention.

Referring to FIGS. 1 and 5, the display apparatus of the present exemplary embodiment includes a 3D switching part different from that of the previous exemplary embodiment. The display apparatus of the present exemplary embodiment includes the same or like parts as those described in the previous exemplary embodiment, except for the 3D switching part. Hereinafter, the same reference numerals will be used to refer to the same or like parts as those described in the previous exemplary embodiment, and any repetitive detailed explanation will be omitted.

According to the present exemplary embodiment, the 3D switching part 600 includes a first substrate 611, a second substrate 612, a third substrate 613, a first LC layer 614, and a second LC layer 615.

A barrier common electrode BCE is disposed on the first substrate 611.

As shown in FIG. 5, the second substrate 612 includes a first surface facing the first substrate 611 and a second surface facing the third substrate 613. A plurality of barrier electrodes BE is disposed on the first surface of the second substrate 612. The barrier electrodes BE may have the same structure as those disposed on the first substrate 531 of the exemplary embodiment shown in FIG. 3A, and any repetitive detailed explanation will be omitted. A plurality of lens electrodes LE is disposed on the second surface of the second substrate 612. The lens electrodes may have the same structure as those disposed on the first substrate 531 of the exemplary embodiment as shown in FIG. 4, and any repetitive detailed explanation will be omitted.

A lens common electrode LCE is disposed on the third substrate 613 opposite the lens electrodes LE.

The first LC layer 614 is disposed between the first substrate 611 and the second substrate 612, and is operated as an opening transmitting the light and a barrier blocking the light according to the driving signal applied to the barrier electrodes BE. According to the present exemplary embodiment, the LC barrier panel may be defined by the first substrate 611, the second substrate 612, and the first LC layer 614.

The second LC layer 615 is disposed between the second substrate 612 and the third substrate 613, and is operated as the unit lens according to the driving signal applied to the lens electrodes LE. According to the present exemplary embodiment, the LC lens panel may be defined by the second substrate 612, the third substrate 613, and the second LC layer 615.

Polarizing plates 631 and 632 may be respectively disposed on a rear surface of the first substrate 611 and a front surface of the third substrate 613.

The 3D switching part 600 according to the present exemplary embodiment includes the second substrate 612 used for both the LC lens panel and the LC barrier panel so that one substrate may be omitted in comparison with that of the exemplary embodiment shown FIG. 1. Therefore, a thickness of the 3D switching part 600 may be decreased and a manufacturing cost may be decreased.

A method of manufacturing the 3D switching part 600 according to the present exemplary embodiment is as follows.

The barrier common electrode BCE is formed on the first substrate 611, and a first alignment layer 616 is formed on the first substrate 611, on which the barrier common electrode BCE is formed, to cover the barrier common electrode BCE.

The lens common electrode LCE is formed on the third substrate 613 and a second alignment layer 617 is formed on the third substrate 613 on which the lens common electrode LCE is formed, to cover the lens common electrode LCE.

The barrier electrodes BE are formed on the first surface of the second substrate 612 and the lens electrodes LE are formed on the second surface facing the first surface of the second substrate 612. A third alignment layer 618 is formed on the first surface of the second substrate 612, on which the barrier electrodes BE are formed, to cover the barrier electrodes BE.

The first surface of the second substrate 612, on which the third alignment layer 618 is formed, is combined with the first substrate 611, on which the first alignment layer 616 is formed, through a combination process, so that the first alignment layer 616 is opposite to the third alignment layer 618.

Then, a fourth alignment layer 619 is formed on the second surface of the second substrate 612 to cover the lens electrodes LE which is formed on the second surface of the second substrate 612. The second surface of the second substrate 612, on which the fourth alignment layer 619 is formed, is combined with the third substrate 613 on which the second alignment layer 617 is formed, through the combination process, so that the second alignment layer 617 is opposite to the forth alignment layer 619.

As described above, the 3D switching part 600 may be manufactured, but not limited thereto.

FIG. 6 is a cross-sectional view of a display apparatus according to an exemplary embodiment of the present invention.

Referring to FIGS. 1 and 6, the display apparatus according to the present exemplary embodiment includes a 3D switching part 620. According to the present exemplary embodiment, the 3D switching part 620 includes a first substrate 611, a second substrate 612, a third substrate 613, a first LC layer 614 and a second LC layer 615.

A plurality of barrier electrodes BE is disposed on the first substrate 611. The barrier electrodes BE may have the same structure as those disposed on the first substrate 531 of the previous exemplary embodiment as shown in FIG. 3A, and any repetitive detailed explanation will be omitted.

As shown in FIG. 6, the second substrate 612 includes a first surface facing the first substrate 611 and a second surface facing the third substrate 613. The barrier common electrode BCE is disposed on the first surface of the second substrate 612. The lens common electrode LCE is disposed on the second surface of the second substrate 612.

A plurality of lens electrodes LE is disposed on the third substrate 613 opposite the lens common electrode LCE. The lens electrodes LE may have the same structure as those disposed on the first substrate 531 of the exemplary embodiment shown in FIG. 4, and any repetitive detailed explanation will be omitted.

The first LC layer 614 is disposed between the first substrate 611 and the second substrate 612, and is operated as an opening transmitting the light and a barrier blocking the light according to the driving signal applied to the barrier electrodes BE. According to the present exemplary embodiment, the LC barrier panel may be defined by the first substrate 611, the second substrate 612, and the first LC layer 614.

The second LC layer 615 is disposed between the second substrate 612 and the third substrate 613, and is operated as the unit lens according to the driving signal applied to the lens electrodes LE. According to the present exemplary embodiment, the LC lens panel may be defined by the second substrate 612, the third substrate 613, and the second LC layer 615.

Polarizing plates 631 and 632 may be respectively disposed on a rear surface of the first substrate 611 and a front surface of the third substrate 613.

The 3D switching part 620 according to the present exemplary embodiment, include the second substrate 612 used for both the LC lens panel and the LC barrier panel so that one substrate may be omitted in comparison with that of the exemplary embodiment shown FIG. 1. Therefore, a thickness of the 3D switching part 600 may be decreased and a manufacturing cost may be decreased.

A method of manufacturing the 3D switching part 620 according to the present exemplary embodiment is as follows.

The plurality of barrier electrodes BE is formed on the first substrate 611, and a first alignment layer 616 is formed on the first substrate 611 on which the barrier electrodes BE are formed, to cover the barrier electrodes BE.

The plurality of lens electrodes LE is formed on the third substrate 613 and a second alignment layer 617 is formed on the third substrate 613 on which the lens electrodes LE are formed, to cover the lens electrodes LE.

The barrier common electrode BCE is formed on the first surface of the second substrate 612 and the lens common electrode LCE is formed on the second surface of the second substrate 612. A third alignment layer 618 is formed on the first surface of the second substrate 612 on which the barrier common electrode BCE is formed, to cover the barrier common electrode BCE.

The first surface of the second substrate 612, on which the third alignment layer 618 is formed, is combined with the first substrate 611, on which the first alignment layer 616 is formed, through a combination process, so that the first alignment layer 616 is opposite the third alignment layer 618.

Then, a fourth alignment layer 619 is formed on the second surface of the second substrate 612 to cover the lens common electrode LCE which is formed on the second surface of the second substrate 612. The second surface of the second substrate 612, on which the fourth alignment layer 619 is formed, is combined with the third substrate 613 on which the second alignment layer 617 is formed, through the combination process, so that the second alignment layer 617 is opposite the fourth alignment layer 619.

As described above, the 3D switching part 620 may be manufactured, but not limited thereto.

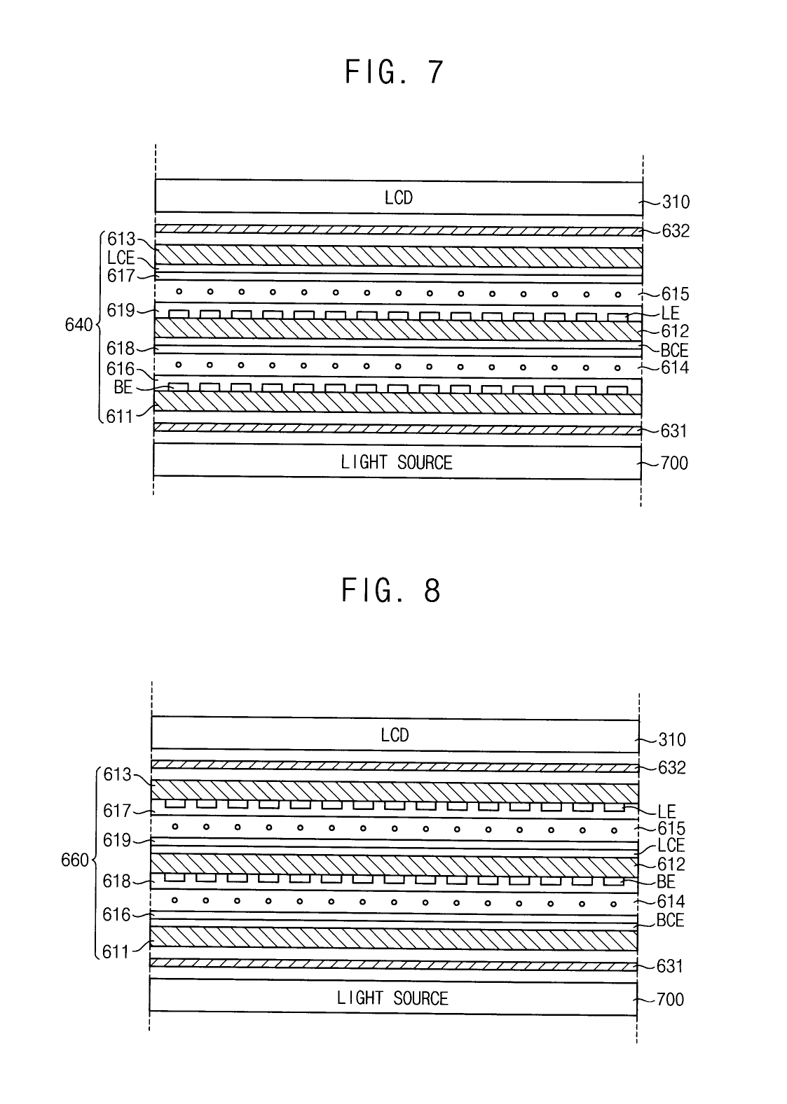

FIG. 7 is a cross-sectional view of a display apparatus according to an exemplary embodiment of the present invention.

Referring to FIGS. 1 and 7, the display apparatus according to the present exemplary embodiment includes a 3D switching part 640. According to the present exemplary embodiment, the 3D switching part 640 includes a first substrate 611, a second substrate 612, a third substrate 613, a first LC layer 614, and a second LC layer 615.

A plurality of barrier electrodes BE is disposed on the first substrate 611. The barrier electrodes BE may have the same structure as those disposed on the first substrate 531 of the exemplary embodiment shown in FIG. 3A, and any repetitive detailed explanation will be omitted.

As shown in FIG. 7, the second substrate 612 includes a first surface facing the first substrate 611 and a second surface facing the third substrate 613. The barrier common electrode BCE is disposed on the first surface of the second substrate 612. The lens electrodes LE are disposed on the second surface of the second substrate 612. The lens electrodes LE may have the same structure as those disposed on the first substrate 531 of the exemplary embodiment shown in FIG. 4, and any repetitive detailed explanation will be omitted. A lens common electrode LCE is disposed on the third substrate 613.

The first LC layer 614 is disposed between the first substrate 611 and the second substrate 612. Thus, the LC barrier panel may be defined by the first substrate 611, the second substrate 612, and the first LC layer 614.

The second LC layer 615 is disposed between the second substrate 612 and the third substrate 613. Thus, the LC lens panel may be defined by the second substrate 612, the third substrate 613, and the second LC layer 615.

Polarizing plates 631 and 632 may be respectively disposed on a rear surface of the first substrate 611 and a front surface of the third substrate 613.

According to the present exemplary embodiment, a thickness of the 3D switching part 640 may be decreased and a manufacturing cost may be decreased.

A method of manufacturing the 3D switching part 640 according to the present exemplary embodiment is as follows.

A plurality of barrier electrodes BE is formed on the first substrate 611, and a first alignment layer 616 is formed on the first substrate 611 on which the barrier electrodes BE are formed, to cover the barrier electrodes BE.

The lens common electrode LCE is formed on the third substrate 613, and a second alignment layer 617 is formed on the third substrate 613 on which the lens common electrode LCE is formed.

The barrier common electrode BCE is formed on the first surface of the second substrate 612 and the lens electrodes LE are formed on the second surface of the second substrate 612. A third alignment layer 618 is formed on the first surface of the second substrate 612 on which the barrier common electrode BCE is formed, to cover the barrier common electrode BCE.

The first surface of the second substrate 612, on which the third alignment layer 618 is formed, is combined with the first substrate 611, on which the first alignment layer 616 is formed, through a combination process, so that the first alignment layer 616 is opposite the third alignment layer 618.

A fourth alignment layer 619 is formed on the second surface of the second substrate 612 to cover the lens electrodes LE, which are formed on the second surface of the second substrate 612. The second surface of the second substrate 612, on which the fourth alignment layer 619 is formed, is combined with the third substrate 613, on which the second alignment layer 617 is formed, through the combination process, so that the second alignment layer 617 is opposite to forth alignment layer 619.

As described above, the 3D switching part 640 may be manufactured, but not limited thereto.

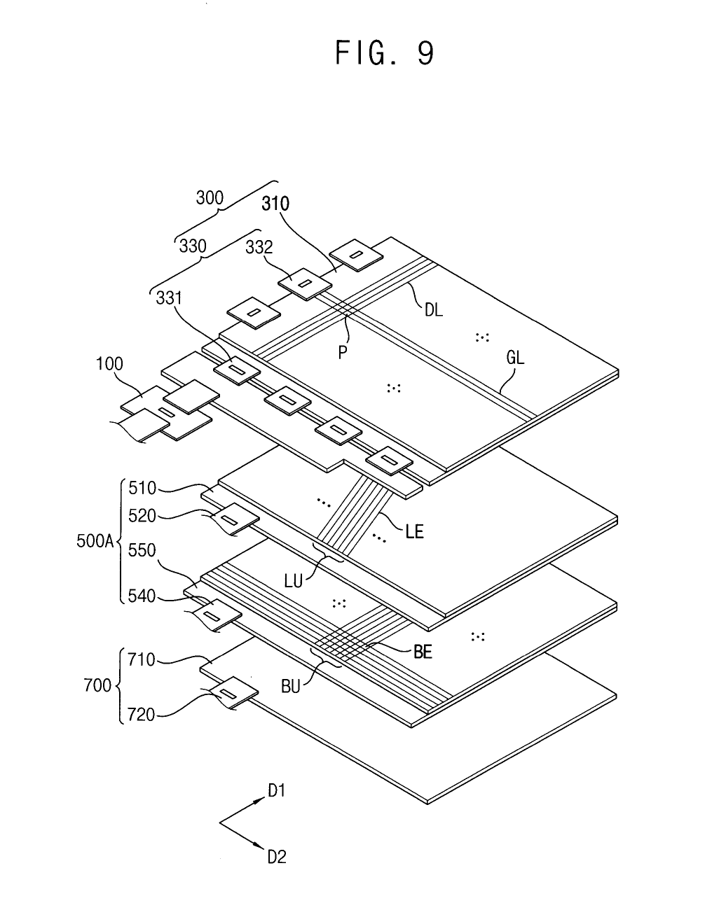

FIG. 8 is a cross-sectional view of a display apparatus according to an exemplary embodiment of the present invention.

Referring to FIGS. 1 and 8, the display apparatus according to the present exemplary embodiment includes a 3D switching part 660. According to the present exemplary embodiment, the 3D switching part 660 includes a first substrate 611, a second substrate 612, a third substrate 613, a first LC layer 614, and a second LC layer 615.

A barrier common electrode BCE is disposed on the first substrate 611.

As shown in FIG. 8, the second substrate 612 includes a first surface facing the first substrate 611 and a second surface facing the third substrate 613. The barrier electrodes BE are disposed on the first surface of the second substrate 612. The barrier electrodes BE may have the same structure as those disposed on the first substrate 531 of the previous exemplary embodiment as shown in FIG. 3A, and any repetitive detailed explanation will be omitted. The lens common electrode LCE is disposed on the second surface of the second substrate 612.

The third substrate 613 includes a plurality of lens electrodes LE. The lens electrodes may have the same structure as those disposed on the first substrate 531 of the exemplary embodiment shown in FIG. 4, and any repetitive detailed explanation will be omitted.

The first LC layer 614 is disposed between the first substrate 611 and the second substrate 612. Thus, the LC barrier panel may be defined by the first substrate 611, the second substrate 612, and the first LC layer 614.

The second LC layer 615 is disposed between the second substrate 612 and the third substrate 613. Thus, the LC lens panel may be defined by the second substrate 612, the third substrate 613, and the second LC layer 615.

Polarizing plates 631 and 632 may be respectively disposed on a rear surface of the first substrate 611 and a front surface of the third substrate 613.

According to the present exemplary embodiment, a thickness of the 3D switching part 660 may be decreased and a manufacturing cost may be decreased.

A method of manufacturing the 3D switching part 660 according to the present exemplary embodiment is as follows.

The barrier common electrode BCE is formed on the first substrate 611, and a first alignment layer 616 is formed on the first substrate 611 on which the barrier common electrode BCE is formed, to cover the barrier common electrode BCE.

The lens electrodes LE are formed on the third substrate 613 and a second alignment layer 617 is formed on the third substrate 613 on which the lens electrodes LE are formed, to cover the lens electrodes LE.

The barrier electrodes BE are formed on the first surface of the second substrate 612, and the lens common electrode LCE is formed on the second surface of the second substrate 612. A third alignment layer 618 is formed on the first surface of the second substrate 612 on which the barrier electrodes BE is formed, to cover the barrier electrodes BE.

The first surface of the second substrate 612, on which the third alignment layer 618 is formed, is combined with the first substrate 611, on which the first alignment layer 616 is formed, through a combination process, so that the first alignment layer 616 is opposite the third alignment layer 618.

A fourth alignment layer 619 is formed on the second surface of the second substrate 612 to cover the lens common electrode LCE which is formed on the second surface of the second substrate 612. The second surface of the second substrate 612, on which the fourth alignment layer 619 is formed, is combined with the third substrate 613 on which the second alignment layer 617 is formed, through the combination process, so that the second alignment layer 617 is opposite the forth alignment layer 619.

As described above, the 3D switching part 660 may be manufactured, but not limited thereto.

FIG. 9 is an exploded perspective view of a display apparatus according to an exemplary embodiment of the present invention.

Referring to FIG. 9, the display apparatus includes a control part 100, a display part 300, a 3D switching part 500A, and a light-source part 700. The display apparatus of the present exemplary embodiment includes a 3D switching part 500A different from that of the previous exemplary embodiment. The display apparatus of the present exemplary embodiment includes the same or like parts as those described in the previous exemplary embodiment, except for the 3D switching part 500A. Hereinafter, the same reference numerals will be used to refer to the same or like parts as those described in the previous exemplary embodiment, and any repetitive detailed explanation will be omitted.

The 3D switching part 500A includes an LC lens panel 510, a lens driving part 520, a LC barrier panel 550, and a barrier driving part 540. The 3D switching part 500A according to the present exemplary embodiment is substantially the same as the 3D switching part 500 as shown in FIG. 1, except for the LC barrier panel 550, and any repetitive detailed explanation will be omitted.

The LC barrier panel 550 is disposed under the LC lens panel 510 and includes a plurality of unit barrier parts BU. Each of the unit barrier parts BU includes a plurality of barrier electrodes BE and the barrier electrodes BE are arranged in a matrix. An area in which a barrier electrode BE is disposed may include a sub pixel area in which a sub pixel is defined. For example, in an RGB stripe structure, the barrier electrode BE may be disposed in an area in which red, green, and blue sub pixels are defined. Alternatively, in a RGBW pentile structure, the barrier electrode BE may be disposed in an area in which red, green, blue, and white sub pixels are defined. Thus, the barrier electrode BE may be disposed in an area corresponding to m×n sub pixel areas (herein, n and m are natural numbers).

The barrier driving part 540 provides the barrier electrodes BE of the unit barrier part BU with the driving signal according to a control of the control part 100. In 3D mode, the barrier driving part 540 drives the unit barrier part BU as the opening transmitting the light and the barrier blocking the light. The barrier driving part 540 controls a position of the barrier based on the left-eye image and the right-eye image displayed on the display panel 310, according to the control of the control part 100. For example, during the first sub frame during which the display panel 310 displays the left-eye image, the first area of the unit barrier part BU is operated as the barrier and the second area of the unit barrier part BU is operated as the opening. In addition, during the second sub frame during which the display panel 310 displays the right-eye image, the first area of the unit barrier part BU is operated as the opening and the second area of the unit barrier part BU is operated as the barrier.

Therefore, during the first sub frame the display panel 310 displays the left-eye image, the light passing through the unit barrier part BU is concentrated on an area in which the observer's left-eye is located. Then, during the second sub frame the display panel 310 displays the right-eye image, the light passing through the unit barrier part BU is concentrated on an area in which the observer's right-eye is located.

In the 2D mode, the barrier driving part 540 drives the entire area of the unit barrier part BU as the opening. Thus, the LC barrier panel 530 is operated as the transparent panel so that the LC barrier panel 530 uniformly transmits the incident light.

According to the present exemplary embodiment, in the 2D mode, the barrier driving part 540 drives the LC barrier panel 550 in a local dimming driving mode based on the control of the control part 100. For example, when an image displayed on the display panel includes a first image which has a high luminance level and a second image which has a background image having a low luminance level less than the high luminance level, the barrier driving part 540 drives a first area of the LC barrier panel 550, corresponding to the first image, as the opening and a second area of the LC barrier panel 550, corresponding to the second image, as the barrier.

Therefore, the second area of the LC barrier panel 550 blocks the light generated from the light-source part 700 and the first area of the LC barrier panel 550 transmits the light generated from the light-source part 700. As described above, the LC barrier panel 550 is selectively operated as the opening and the barrier by every local area according to the luminance of the image displayed on the display panel so that an effectiveness of the local dimming driving mode may be obtained.

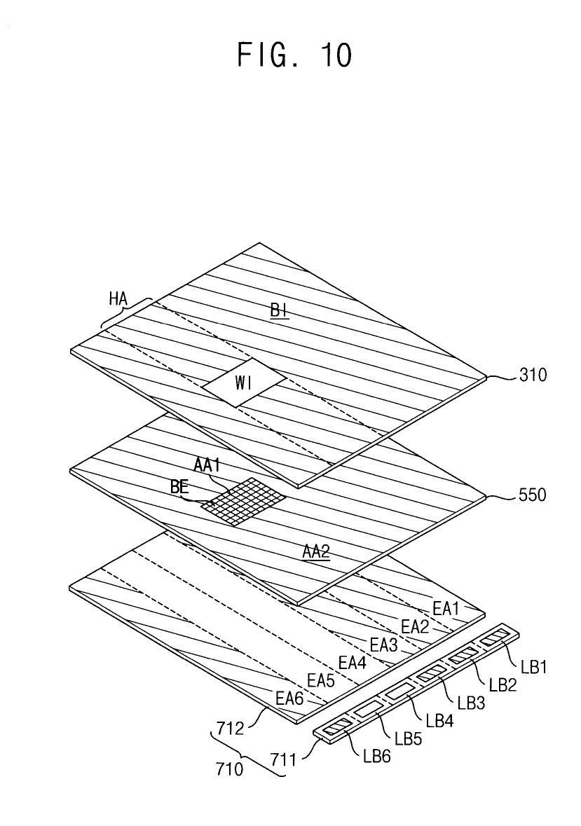

FIG. 10 is an exploded perspective view illustrating a method of driving the liquid crystal barrier panel according to the display apparatus as shown in FIG. 9.

Referring to FIGS. 9 and 10, the display apparatus includes a display panel 310, an LC barrier panel 550, and a light-source unit 710. The light-source unit 710 includes a light-source module 711 and a light guide plate (“LGP”) 712.

The light-source module 711 includes a plurality of light-emitting blocks LB1, LB2, . . . , LB6. The light-emitting blocks LB1, LB2, . . . , LB6 are arranged in a single direction and are individually driven. Each of the light-emitting blocks LB1, LB2, . . . , LB6 includes at least one light-source. The light-source module 711 is disposed at an edge of the LGP 712.

The LGP 712 may be divided into a plurality of light-emitting areas EA1, EA2, . . . , EA6 according to the light emitted from each of the light-emitting blocks LB1, LB2, . . . , LB6. Therefore, the light-source unit 710 may be driven as a one-dimensional (“1D”) local dimming driving mode.

As shown in FIG. 10, the display panel 310 displays a frame image which including a white image WI of the high luminance level and a black image BI of the low luminance level.

In this case, the light-emitting blocks LB1, LB2, . . . , LB6 of the light-source module 711 are individually driven based on the frame image such that a ratio of the white image WI and the black image BI may increase. For example, third and fourth light-emitting blocks LB3 and LB4 corresponding to a first area AA1 displaying the white image WI are driven with a high luminance, and first, second, and fifth light-emitting blocks LB1, LB2 and LB5 corresponding to a second area AA2 displaying the black image BI are driven with a low luminance. Thus, third and fourth light-emitting areas EA3 and EA4 of the LGP 712 corresponding to the third and fourth light-emitting blocks LB3 and LB4 have the high luminance, and thus a horizontal area which includes the first area AA displaying the white image WI has the high luminance.

According to the present exemplary embodiment, when the light-source unit 710 is driven in the 1D local dimming driving mode, the LC barrier panel 550 is selectively operated as the opening and the barrier by every local area, so that the effectiveness of a 2D local dimming driving mode may be obtained.

For example, the first area AA1 of the LC barrier panel 550 corresponding to the white image WI is operated as the opening, and the second area AA2 of the LC barrier panel 550 corresponding to the black image BI is operated as the barrier.

The barrier electrodes BE in the first area AA1 receive the driving signal which has a potential difference from the driving signal applied to the barrier common electrode, and the barrier electrodes BE in the second area AA2 receive the driving signal which is the same as the driving signal applied to the barrier common electrode. Thus, the first area AA1 of the LC barrier panel 550 transmits the light and the second area AA2 of the LC barrier panel 550 blocks the light.

According to the 1D local dimming driving mode of the light-source unit 710, the third and fourth light-emitting areas EA3 and EA4 have the high luminance. In this case, according to the present exemplary embodiment, the first area AA1 of the LC barrier panel 550 is operated as the opening and the horizontal area except for the first area AA1 is operated as the barrier, so that the white image WI corresponding to the first AA1 may be displayed with the high luminance.

Therefore, the display apparatus may more brightly display the white image WI and more darkly display the black image BI.

According to the present exemplary embodiment, when the light-source unit 710 drives in the 1D local dimming driving mode, the LC barrier panel 550 is operated as the opening and the barrier by every local area so that the effectiveness of the 2D local dimming mode may be obtained.

In addition, although not shown in the figures, when the light-source part 711 does not drive in the 1D local dimming driving mode, the LC barrier panel 550 is operated as the opening and the barrier by every local area so that the effectiveness of the 2D local dimming mode may be obtained.

According to the exemplary embodiments of the present invention, the display apparatus may selectively display the 2D image and the 3D image through the LC lens panel. In addition, every local area of the LC barrier panel of the display apparatus, which includes the barrier electrodes arranged in a matrix, is controlled so that the effectiveness of the local to dimming mode may be obtained.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A display apparatus, comprising:
a display panel configured to selectively display a two-dimensional (“2D”) image and a three-dimensional (“3D”) image;
a light-source unit configured to provide the display panel with light;
a liquid crystal (“LC”) barrier panel disposed between the display panel and the light-source unit and comprising a unit barrier part, the unit barrier part comprising a plurality of barrier electrodes configured to be driven to form a barrier blocking the light and an opening transmitting the light; and
an LC lens panel disposed between the LC barrier panel and the display panel and comprising a unit lens part, the unit lens part comprising a plurality of lens electrodes configured to be driven as a unit lens.

2. The display apparatus of claim 1, wherein when the display panel is configured to display a left-eye image, one of the plurality of barrier electrodes in a first area of the unit barrier part is configured to form the barrier and another one of the plurality of barrier electrodes in a second area of the unit barrier part is configured to form the opening, and
when the display panel is configured to display a right-eye image, the one of the plurality of barrier electrodes in the first area of the unit barrier part is configured to form the opening and the another one of the plurality of barrier electrodes in the second area of the unit barrier part is configured to form the barrier.

3. The display apparatus of claim 2, wherein when the display panel is configured to display the left-eye image and the right-eye image, the plurality of lens electrodes of the unit lens part is configured to operate as the unit lens.

4. The display apparatus of claim 2, wherein when the display panel is configured to display the 2D image, an entire area of the unit barrier part is configured to form the opening.

5. The display apparatus of claim 4, wherein when the display panel is configured to display the 2D image, the unit lens part is configured to operate in a transparent mode.

6. The display apparatus of claim 1, wherein the LC barrier panel comprises a first substrate, a second substrate comprising a first surface facing a first surface of the first substrate, and a first LC layer disposed between the first substrate and the second substrate, and
the LC lens panel comprises the second substrate, a third substrate facing a second surface of the second substrate, and a second LC layer disposed between the second substrate and the third substrate.

7. The display apparatus of claim 6, wherein a barrier common electrode is disposed on the first surface of first substrate, the plurality of barrier electrodes is disposed on the first surface of the second substrate, a lens common electrode is disposed on a first surface of the third substrate, and the plurality of lens electrodes is disposed on the second surface of the second substrate.

8. The display apparatus of claim 6, wherein the plurality of barrier electrodes is disposed on the first surface of the first substrate, a barrier common electrode is disposed on a first surface of the second substrate, the plurality of lens electrodes is disposed on a first surface of the third substrate, and a lens common electrode is disposed on the second surface of the second substrate.

9. The display apparatus of claim 6, further comprising:
a pair of polarizing plates respectively disposed on a second surface of the first substrate and on a second surface of the third substrate.

10. The display apparatus of claim 1, wherein the plurality of barrier electrodes extends in a first direction and is arranged in a second direction crossing the first direction.

11. The display apparatus of claim 10, wherein the plurality of lens electrodes extends in a lens axis direction inclined with respect to the first direction and is arranged in the second direction.

12. The display apparatus of claim 1, wherein the plurality of barrier electrodes is arranged in a matrix.

13. The display apparatus of claim 12, wherein each of the plurality of barrier electrodes has a size corresponding to a sub pixel area of the display panel.

14. The display apparatus of claim 12, wherein each of the plurality of barrier electrodes has a size corresponding to a plurality of sub pixel areas of the display panel.

15. The display apparatus of claim 12, wherein the LC barrier panel is configured to operate as the opening and the barrier by every local area based on the luminance level of a block image displayed on the display panel.

16. The display apparatus of claim 12, wherein the light-source unit comprises a plurality of light-emitting blocks, the light-emitting blocks arranged in a single direction and configured to individually emit the light according to a luminance level of a block image displayed on the display panel.

17. The display apparatus of claim 16, wherein the LC barrier panel is configured to operate as the opening and the barrier by every local area based on the luminance level of a block image displayed on the display panel.

18. The display apparatus of claim 1, wherein the plurality of lens electrodes comprises a double-layer structure.

19. The display apparatus of claim 6, wherein the plurality of barrier electrodes is disposed on the first surface of the first substrate, a barrier common electrode is disposed on a first surface of the second substrate, a lens common electrode is disposed on a first surface of the third substrate, and the plurality of lens electrodes is disposed on the second surface of the second substrate.

20. The display apparatus of claim 6, wherein a barrier common electrode is disposed on the first surface of the first substrate, the plurality of barrier electrodes is disposed on a first surface of the second substrate, the plurality of lens electrodes is disposed on a first surface of the third substrate, and a lens common electrode is disposed on the second surface of the second substrate.
